(19) United States
(12) Patent Application Publication
(10) Pub. No.: US 2022/0044375 A1
(43) Pub. Date: Feb. 10, 2022

(54) Saliency Map Enhancement-Based Infrared and Visible Light Fusion Method

(71) Applicant: DALIAN UNIVERSITY OF TECHNOLOGY, Dalian, Liaoning (CN)

(72) Inventors: Risheng LIU, Dalian, Liaoning (CN); Xin FAN, Dalian, Liaoning (CN); Jinyuan LIU, Dalian, Liaoning (CN); Wei ZHONG, Dalian, Liaoning (CN); Zhongxuan LUO, Dalian, Liaoning (CN)

(21) Appl. No.: 17/283,181

(22) PCT Filed: Mar. 5, 2020
(86) PCT No.: PCT/CN2020/077956

§ 371 Date: Apr. 6, 2021

(30) Foreign Application Priority Data
Dec. 17, 2019 (CN) 201911304499.4

(51) Int. Cl. G06T 5/50; G06T 5/00; G06T 7/80

(52) U.S. Cl. CPC G06T 5/50; G06T 5/006; G06T 2207/20221; G06T 2207/10048; G06T 2207/20024; G06T 7/80

(57) ABSTRACT

The present invention proposes a saliency map enhancement-based infrared and visible light fusion method, which is an infrared and visible light fusion algorithm using filtering decomposition and significant enhancement. Binocular cameras and NVIDIA TX2 are used to construct a high-performance computing platform and to construct a high-performance solving algorithm to obtain a high-quality infrared and visible light fusion image. The system is easy to construct, and the input data can be acquired by using stereo binocular infrared and visible light cameras respectively; the program is simple and easy to implement; the input image is decomposed into a background layer and a detail layer by means of filtering decomposition according to different imaging principles of infrared and visible light cameras, a saliency map enhancement-based fusion method is designed for the background layer, and a pixel contrast-based fusion algorithm is designed for the detail layer.

### TECHNICAL FIELD

The present invention belongs to the field of image processing and computer vision, adopts a pair of infrared camera and visible light camera to acquire images, and relates to an image fusion algorithm for construction of image salient information, which is an infrared and visible light fusion algorithm using image enhancement.

### BACKGROUND

The binocular stereo vision technology based on visible light band is developed to be relatively mature. Visible light imaging has rich contrast, color and shape information, so the matching information between binocular images can be obtained accurately and quickly so as to obtain scenario depth information. However, visible light band imaging has defects, and the imaging quality thereof is greatly reduced, for example, in strong light, fog rain, snow or night, which affects the matching precision. Therefore, the establishment of a color fusion system by using the complementarity of different band information sources is an effective way to produce more credible images in special environments. For example, a visible light band binocular camera and an infrared band binocular camera are used to constitute a multi-band stereo vision system, and the advantage of not being affected by fog, rain, snow and light of infrared imaging is used to make up for the deficiency of visible light band imaging so as to obtain more complete and precise fusion information.

The multi-modality image fusion technology is an image processing algorithm^{[1-3]} that uses the complementarity and redundancy between a plurality of images and adopts a specific algorithm or rule for fusion to obtain images with high credibility and better vision. Compared with the singularity of the mono-modality fusion image, multi-modality image fusion can better obtain the interactive information of images in different modalities, and gradually becomes an important means for disaster monitoring, unmanned driving, military monitoring and deep space exploration. The goal is to use the difference and complementarity of imaging of sensors with different modalities to extract the image information of each modality to the greatest extent and use source images of different modalities to fuse a composite image with abundant information and high fidelity. Therefore, the multi-modality image fusion will produce more comprehensive understanding and more accurate positioning of the image. In recent years, most of fusion methods are researched and designed based on the transform domain without considering the multi-scale detail information of images, resulting in the loss of details in the fused image, for example, the public patent CN208240087U [Chinese], an infrared and visible light fusion system and image fusion device. Therefore, the present invention performs optimization solution after mathematical modeling of infrared and visible light, and realizes the enhancement of details and the removal of artifacts on the basis of retaining the effective information of infrared and visible light images.

### SUMMARY

The present invention aims to overcome the defects of the prior art and provide a saliency map enhancement-based real-time fusion algorithm. Through the design, filtering decomposition is carried out on infrared and visible light images to obtain a background layer and a detail layer, saliency map enhancement is carried out on the background layer, contrast-based fusion is carried out on the detail layer, and finally, the real-time performance is achieved through GPU acceleration.

The present invention has the following specific technical solution:

A saliency map enhancement-based infrared and visible light fusion method, comprises the following steps:

1) Obtaining registered infrared and visible light images, and respectively calibrating each lens and jointly calibrating the respective systems of the visible light binocular camera and the infrared binocular camera;

1-1) Respectively calibrating the infrared camera and the visible light camera by the Zhangzhengyou calibration method to obtain internal parameters including focal length and principal point position and external parameters including rotation and translation of each camera;

1-2) Calculating the positional relationship of the same plane in the visible light image and the infrared image by using the pose relationship RT (rotation matrix and translation vector) of the visible light camera and the infrared camera obtained by joint calibration of the cameras and the detected checker corners, and registering the visible light image to the infrared image (the infrared image to the visible light image) by using homography transformation;

2) Converting the color space of the visible light image from an RGB image to an HSV image, extracting the value information of the color image as the input of image fusion, and retaining the original hue and saturation;

2-1) In view of the problem that the visible light image has RGB three channels, converting the RGB color space to the HSV color space, wherein V is value, H is hue and S is saturation; and extracting the value information of the visible light image to be fused with the infrared image, and retaining the hue and saturation, wherein the specific conversion is shown as follows:

R′=R/255 G′=G/255 B′=B/255

Cmax=max(R′,G′,B′)

Cmin=min(R′,G′,B′)

Δ=Cmax−Cmin

V=Cmax

2-2) Extracting the V channel as the input of visible light, retaining H and S to the corresponding matrix, and retaining the color information for the subsequent color restoration after fusion.

3) Carrying out mutual guided filtering decomposition on the input infrared image and the visible light image with the color space converted, and decomposing the images into a background layer and a detail layer, wherein the background layer includes the structural information of the images, and the detail layer includes the gradient and texture information of the images.

B=M(I,V), D=(I,V)−B

wherein B represents the background layer, D represents the detail layer, M represents the mutual guided filtering, and I represents the infrared image;

4) Fusing the background layer B by the saliency map-based method, subtracting each pixel from all the pixels, and taking and adding absolute values, wherein the formula is as follows:

S(p)=|I(p)−I₁|+|I(p)−I₂|+|I(p)−I₃|+ ⋅ ⋅ ⋅ +|I(p)−I_{N}|

That is:

$$S ( p ) = {\sum }_{i = 0}^{255} M ( i ) \vert I ( p ) - i \vert$$

wherein S(p) represents the salience value of the pixel, N represents the number of pixels in the image, M represents the histogram statistical formula, and I(p) represents the value of the pixel position;

According to the obtained saliency value, obtaining the saliency map weight based on background layer fusion:

$$W = \frac{S ( p )}{\sum {S ( p )}_{j}}$$

wherein W represents the weight, and S(p)ⱼ represents the corresponding pixel value; then performing linearly weighted fusion of the decomposed infrared image and visible light image based on the saliency map weight, wherein the calculation formula is as follows:

B=0.5*(0.5+I*(W₁−W₂)*0.5)+0.5*(0.5+V*(W₂−W₁)*0.5)

wherein I and V represent the input infrared image and visible light image respectively, and W₁ and W₂ represent the salience weights obtained for the infrared image and visible light image respectively;

5) Implementing the contrast-based pixel fusion strategy for the detail layer obtained after object difference, designing a sliding window to perform global sliding on the detail images of infrared and visible light respectively, comparing the pixel values of the corresponding detail images, and taking 1 if the values of eight neighborhoods of the current pixel of the infrared image are greater than those of eight neighborhoods of the corresponding pixel of the visible light. Otherwise, taking 0; generating the corresponding binary weight map X according to the scanned sliding window; and then fusing the detail layer;

D=D(I)*X+D(V)*(1−X)

6) Linearly weighting the background layer and the detail layer to obtain:

F=B+D

wherein F represents the fusion result, and B and D represent the background layer fusion result and detail layer fusion result;

7) Converting the color space: converting the fusion image back to the RGB image, and adding the hue and saturation previously retained;

Restoring to the RGB color space from the HSV color space by updating the V information saved into the fusion image in combination with the previously retained H and S; wherein the specific formulas are shown as follows:

$$C = V \times S \\ X = C \times ( 1 - \vert ( H \text{/} 60 ° ) mod 2 - 1 \vert )$$

$$m = V - C \\ ( {R}^{′} , {G}^{′} , {B}^{′} ) = \{ \begin{matrix}( C , X , 0 ) , & 0 ° \leq H < 60 ° \\ ( X , C , 0 ) , & 60 ° \leq H < 120 ° \\ ( 0 , C , X ) , & 120 ° \leq H < 180 ° \\ ( 0 , X , C ) , & 180 ° \leq H < 240 ° \\ ( X , 0 , C ) & 240 ° \leq H < 300 ° \\ ( C , 0 , X ) , & 300 ° \leq H < 360 °\end{matrix} \\ {R}^{′} , {G}^{′} , {B}^{′} = ( ( {R}^{′} + m ) \times 2 \; 55 , \\ ( {G}^{′} + m ) \times 2 \; 55 , ( {B}^{′} + m ) \times 255 )$$

wherein C is the product of the value and the saturation; and in is the difference of the value and C.

8) Enhancing the color: enhancing the color of the fusion image to generate a fusion image with higher resolution and contrast; and performing pixel-level image enhancement for the contrast of each pixel.

Performing color correction and enhancement on the restored image to generate a three-channel image that is consistent with observation and detection; and performing color enhancement on the R channel, G channel and B channel respectively to obtain the final fusion image. The specific formulas are shown as follows:

Rₒᵤₜ=(Rᵢₙ)^{1/gamma}

R_{display}=(Rᵢₙ^{(1/gamma)})^{gamma}

Gₒᵤₜ=(Gᵢₙ)^{1/gamma}

G=(Gᵢₙ^{(1/gamma)})^{gamma}

Bₒᵤₜ=(Bᵢₙ)^{1/gamma}

B_{display}=(Bᵢₙ^{(1/gamma)})^{gamma}

wherein gamma is the correction parameter, Rᵢₙ, Gᵢₙ and Bᵢₙ are the values of the three input channels R, G, and B respectively, Rₒᵤₜ, Gₒᵤₜ and Bₒᵤₜ are the intermediate parameters, and R_{display}, G_{display} and B_{display} are the values of the three channels after enhancement.

The present invention has the following beneficial effects:

The present invention proposes a real-time fusion method using infrared and visible light binocular stereo cameras. The image is decomposed into a background layer and a detail layer by using the filtering decomposition strategy, and different strategies are merged in the background layer and the detail layer respectively, effectively reducing the interference of artifacts and fusing a highly reliable image. The present invention has the following characteristics:

(1) The system is easy to construct, and the input data can be acquired by using stereo binocular cameras;

(2) The program is simple and easy to implement;

(3) The image is decomposed into two parts and specifically solved by means of filtering decomposition;

(4) The structure is complete, multi-thread operation can be performed, and the program is robust;

(5) The detail images are used to perform significant enhancement and differentiation to improve the generalization ability of the algorithm.

### DESCRIPTION OF DRAWINGS

FIG. 1 is a flow chart of a visible light and infrared fusion algorithm.

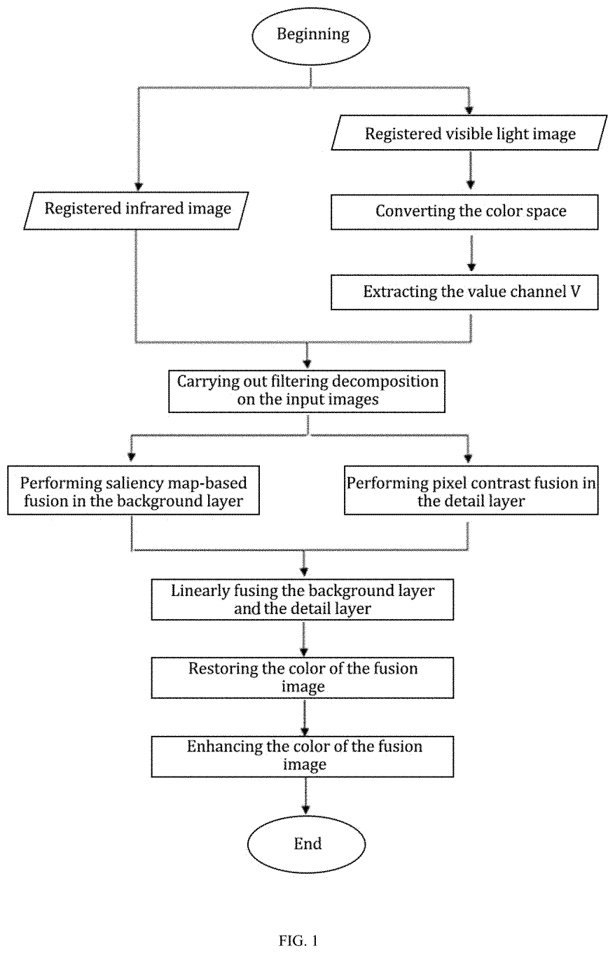

FIG. 2 is a final fusion image.

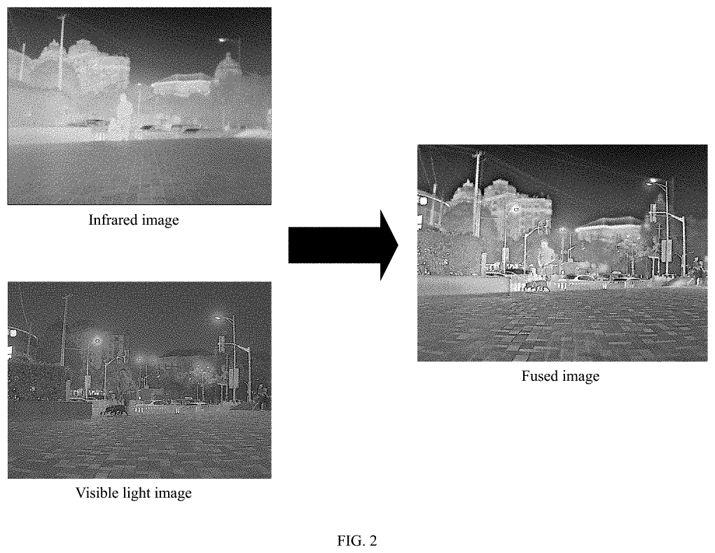

### DETAILED DESCRIPTION

The present invention proposes a method for real-time image fusion by an infrared camera and a visible light camera, and will be described in detail below in combination with drawings and embodiments.

The visible light camera and the infrared camera are placed on a fixed platform, the image resolution of the experiment cameras is 1280×720, and the field of view is 45.4°. To ensure real-time performance, NVIDIA TX2 is used for calculation. On this basis, a real-time infrared and visible light fusion method is designed, and the method comprises the following steps:

1) Obtaining registered infrared and visible light images;

1-1) Respectively calibrating the infrared camera and the visible light camera by the Zhangzhengyou calibration method to obtain internal parameters such as focal length and principal point position and external parameters such as rotation and translation of each camera.

1-2) Calculating the positional relationship of the same plane in the visible light image and the infrared image by using the pose relationship RT (rotation matrix and translation vector) of the visible light camera and the infrared camera obtained by joint calibration of the cameras and the detected checker corners, and registering the visible light image to the infrared image (the infrared image to the visible light image) by using homography transformation.

2) Converting the color space of the image

2-1) In view of the problem that the visible light image has RGB three channels, converting the RGB color space to the HSV color space, extracting the V (value) information of the visible light image to be fused with the infrared image, and retaining H (hue) and S (saturation), wherein the specific conversion is shown as follows:

R′=R/255 G′=G/255 B′=B/255

Cmax=max(R′,G′,B′)

Cmin=min(R′,G′,B′)

Δ=Cmax−Cmin

V=Cmax

2-2) Retaining H (hue) and S (saturation) channel information, retaining the color information for the subsequent color restoration after fusion, and extracting the V (value) channel as the input of visible light;

3) Carrying out mutual guided filtering decomposition for the input infrared image and the visible light image with the color space converted, and decomposing the images into a background layer and a detail layer, wherein the background layer depicts the structural information of the images, and the detail layer depicts the gradient and texture information.

B=M(I,V), D=(I,V)−B

wherein B represents the background layer, D represents the detail layer, M represents the mutual guided filtering, and I represents the infrared image.

4) Designing a saliency map-based method to fuse the background layer B, subtracting each pixel from all the pixels, and taking and adding absolute values, wherein the formula is as follows:

S(p)=|I(p)−I₁|+|I(p)−I₂|+|I(p)−I₃|+⋅⋅⋅+|I(p)−I_{N}|

That is:

$$S ( p ) = {\sum }_{i = 0}^{255} M ( i ) \vert I ( p ) - i \vert$$

wherein S(p) represents the salience value of the pixel, N represents the number of pixels in the image, M represents the histogram statistical formula, and I represents the value of the pixel in the image;

According to the obtained saliency value, the saliency map weight based on background layer fusion can be obtained:

$$W = \frac{S}{\sum {S}_{j}}$$

wherein W represents the weight, and Sⱼ represents the corresponding pixel value; then performing linearly weighted fusion of the decomposed infrared image and visible light image based on the saliency map weight, wherein the calculation formula is as follows:

B=0.5*(0.5+I*(W₁−W₂)*0.5)+0.5*(0.5+V*(W₂−W₁)*0.5)

wherein I and V represent the input infrared image and visible light image respectively, and W₁ and W₂ represent the salience weights obtained for the infrared image and visible light image respectively.

5) Implementing the contrast-based pixel fusion strategy for the detail layer obtained after object difference, designing a sliding window with the size of 3*3 to perform global sliding on the detail images of infrared and visible light respectively, comparing the pixel values of the corresponding detail images, and taking 1 if the values are saved in the corresponding window; otherwise, taking 0; and generating the corresponding binary weight map X according to the scanned sliding window. Then fusing the detail layer;

D=D(I)*X+D(V)*(1−X)

6) Finally, linearly weighting the background layer and the detail layer to obtain:

F=B+D

wherein F represents the fusion result, and B and D represent the background layer fusion result and detail layer fusion result.

7-1) Restoring to the RGB color space from the HSV color space by updating the V (value) information saved into the fusion image in combination with the previously retained H (hue) and S (saturation), wherein the specific formulas are shown as follows:

$$C = V \times S$$

$$X = C \times ( 1 - \vert ( H \text{/} 60 ° ) mod 2 - 1 \vert )$$

$$m = V - C \\ ( {R}^{′} , {G}^{′} , {B}^{′} ) = \{ \begin{matrix}( C , X , 0 ) , & 0 ° \leq H < 60 ° \\ ( X , C , 0 ) , & 60 ° \leq H < 120 ° \\ ( 0 , C , X ) , & 120 ° \leq H < 180 ° \\ ( 0 , X , C ) , & 180 ° \leq H < 240 ° \\ ( X , 0 , C ) & 240 ° \leq H < 300 ° \\ ( C , 0 , X ) , & 300 ° \leq H < 360 °\end{matrix} \\ {R}^{′} , {G}^{′} , {B}^{′} = ( ( {R}^{′} + m ) \times 2 \; 55 , \\ ( {G}^{′} + m ) \times 2 \; 55 , ( {B}^{′} + m ) \times 255 )$$

wherein C is the product of the value and the saturation; and in is the difference of the value and C.

7-2) Performing color correction and enhancement on the image restored in step 7-1 to generate a three-channel image that is consistent with observation and detection; and performing color enhancement on the R channel, G channel and B channel respectively, wherein the specific formulas are shown as follows:

Rₒᵤₜ=(Rᵢₙ)^{1/gamma}

R_{display}=(Rᵢₙ^{(1/gamma)})^{gamma}

Gₒᵤₜ=(Gᵢₙ)^{1/gamma}

G=(Gᵢₙ^{(1/gamma)})^{gamma}

Bₒᵤₜ=(Bᵢₙ)^{1/gamma}

B_{display}=(Bᵢₙ^{(1/gamma)})^{gamma}

wherein gamma is the correction parameter, Rᵢₙ, Gᵢₙ and Bᵢₙ are the values of the three input channels R, G, and B respectively, Rₒᵤₜ, Gₒᵤₜ and Bₒᵤₜ are the intermediate parameters, and R_{display}, G_{display} and B_{display} are the values of the three channels after enhancement.

1. A saliency map enhancement-based infrared and visible light fusion method, wherein the method comprises the following steps:
1) obtaining registered infrared and visible light images, and respectively calibrating each lens and jointly calibrating the respective systems of the visible light binocular camera and the infrared binocular camera;
1-1) respectively calibrating the infrared camera and the visible light camera by the Zhangzhengyou calibration method to obtain internal parameters including focal length and principal point position and external parameters including rotation and translation of each camera;
1-2) calculating the positional relationship of the same plane in the visible light image and the infrared image by using the pose relationship RT of the visible light camera and the infrared camera obtained by joint calibration of the cameras and the detected checker corners, and registering the visible light image to the infrared image by using homography transformation;
2) converting the color space of the visible light image from an RGB image to an HSV image, extracting the value information of the color image as the input of image fusion, and retaining the original hue and saturation;
3) carrying out mutual guided filtering decomposition on the input infrared image and the visible light image with the color space converted, and decomposing the images into a background layer and a detail layer, wherein the background layer includes the structural information of the images, and the detail layer includes the gradient and texture information of the images;
B=M(I,V), D=(I,V)−B
wherein B represents the background layer, D represents the detail layer, M represents the mutual guided filtering, and I represents the infrared image;
4) fusing the background layer B by the saliency map-based method, subtracting each pixel from all the pixels, and taking and adding absolute values, wherein the formula is as follows:
S(p)=|I(p)−I₁|+|I(p)−I₂|+|I(p)−I₃|+ ⋅ ⋅ ⋅ +|I(p)−I_{N}|

that is
$$S ( p ) = {\sum }_{i = 0}^{255} M ( i ) \vert I ( p ) - i \vert$$
wherein S(p) represents the salience value of the pixel, N represents the number of pixels in the image, M represents the histogram statistical formula, and I(p) represents the value of the pixel position;
according to the obtained saliency value, obtaining the saliency map weight based on background layer fusion:
$$W = \frac{S ( p )}{\sum {S ( p )}_{j}}$$
wherein W represents the weight, and Sⱼ represents the corresponding pixel value; then performing linearly weighted fusion of the decomposed infrared image and visible light image based on the saliency map weight, wherein the calculation formula is as follows:
B=0.5*(0.5+I*(W₁−W₂)*0.5)+0.5*(0.5+V*(W₂−W₁)*0.5)
wherein I and V represent the input infrared image and visible light image respectively, and W₁ and W₂ represent the salience weights obtained for the infrared image and visible light image respectively;
5) implementing the contrast-based pixel fusion strategy for the detail layer obtained after object difference, designing a sliding window to perform global sliding on the detail images of infrared and visible light respectively, comparing the pixel values of the corresponding detail images, and taking 1 if the values of eight neighborhoods of the current pixel of the infrared image are greater than those of eight neighborhoods of the corresponding pixel of the visible light; otherwise, taking 0; generating the corresponding binary weight map X according to the scanned sliding window; and then fusing the detail layer;
D=D(I)*X+D(V)*(1−X)
6) linearly weighting the background layer and the detail layer to obtain:
F=B+D
wherein F represents the fusion result, and B and D represent the background layer fusion result and detail layer fusion result;
7) converting the color space: converting the fusion image back to the RGB image, and adding the hue and saturation previously retained;
restoring to the RGB color space from the HSV color space by updating the V information saved into the fusion image in combination with the previously retained H and S;
8) enhancing the color: enhancing the color of the fusion image to generate a fusion image with higher resolution and contrast; and performing pixel-level image enhancement for the contrast of each pixel;
performing color correction and enhancement on the restored image to generate a three-channel image that is consistent with observation and detection; and performing color enhancement on the R channel, G channel and B channel respectively to obtain the final fusion image.

2. The saliency map enhancement-based infrared and visible light fusion method according to claim 1, wherein the color space conversion of the visible light image in step 2) comprises:
2-1) converting the RGB color space to the HSV color space, wherein V is value, H is hue and S is saturation; and extracting the value information of the visible light image to be fused with the infrared image, and retaining the hue and saturation, wherein the specific conversion is shown as follows:
R′=R/255 G′=G/255 B′=B/255
Cmax=max(R′,G′,B′)
Cmin=min(R′,G′,B′)
Δ=Cmax−Cmin
V=Cmax
2-2) extracting the V channel as the input of visible light, retaining H and S to the corresponding matrix, and retaining the color information for the subsequent color restoration after fusion.

3. The saliency map enhancement-based infrared and visible light fusion method according to claim 1, wherein the specific formulas for color space conversion in step 7) are shown as follows:
$$C = V \times S$$
$$X = C \times ( 1 - \vert ( H \text{/} 60 ° ) mod 2 - 1 \vert )$$
$$m = V - C \\ ( {R}^{′} , {G}^{′} , {B}^{′} ) = \{ \begin{matrix}( C , X , 0 ) , & 0 ° \leq H < 60 ° \\ ( X , C , 0 ) , & 60 ° \leq H < 120 ° \\ ( 0 , C , X ) , & 120 ° \leq H < 180 ° \\ ( 0 , X , C ) , & 180 ° \leq H < 240 ° \\ ( X , 0 , C ) & 240 ° \leq H < 300 ° \\ ( C , 0 , X ) , & 300 ° \leq H < 360 °\end{matrix} \\ {R}^{′} , {G}^{′} , {B}^{′} = ( ( {R}^{′} + m ) \times 2 \; 55 , \\ ( {G}^{′} + m ) \times 2 \; 55 , ( {B}^{′} + m ) \times 255 )$$
wherein C is the product of the value and the saturation; and in is the difference of the value and C.

4. The saliency map enhancement-based infrared and visible light fusion method according to claim 1, wherein the specific formulas for color enhancement in step 8) are shown as follows:
Rₒᵤₜ=(Rᵢₙ)^{1/gamma}
R_{display}=(Rᵢₙ^{(1/gamma)})^{gamma}
Gₒᵤₜ=(Gᵢₙ)^{1/gamma}
G=(Gᵢₙ^{(1/gamma)})^{gamma}
Bₒᵤₜ=(Bᵢₙ)^{1/gamma}
B_{display}=(Bᵢₙ^{(1/gamma)})^{gamma}
wherein gamma is the correction parameter, Rᵢₙ, Gᵢₙ and Bᵢₙ are the values of the three input channels R, G, and B respectively, Rₒᵤₜ, Gₒᵤₜ and Bₒᵤₜ are the intermediate parameters, and R_{display}, G_{display} and B_{display} are the values of the three channels after enhancement.
